(19) United States
(12) Patent Application Publication
(10) Pub. No.: US 2002/0133539 A1
(43) Pub. Date: Sep. 19, 2002

(54) Dynamic logical storage volumes

(75) Inventor: Paul R. Monday, Rochester, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 09/808,313

(22) Filed: Mar. 14, 2001

(51) Int. Cl. G06F 12/00

(52) U.S. Cl. 709/203; 711/172; 709/220

(57) ABSTRACT

Techniques for dynamically and automatically incorporating storage capacity of a remote storage device into one or more existing logical storage volumes when a remote network attached storage (NAS) device is attached to a network. A NAS master coupled to the network includes a NAS sensing module configured to detect the attachment of the remote NAS storage device to a network. A NAS management module executing within the NAS master is configured to interact with a logical volume manager (LVM) and automatically incorporate storage capacity of the detected remote storage device into the existing logical storage volumes.

### TECHNICAL FIELD

The invention relates to data storage and, more particularly, to dynamic logical storage volumes in a computer network.

### BACKGROUND

Network Attached Storage (NAS) technology has recently emerged as a highly-scalable storage solution. A NAS server is a self-contained data storage appliance that attaches directly to an existing network. NAS technology may offer several advantages over conventional storage devices including independent storage, improved performance, rapid deployment, increased scalability and lower-cost per storage unit.

NAS servers, as well as more conventional storage devices are typically managed according to a hierarchy of logical structures and concepts including physical volumes, volume groups, physical partitions, logical volumes, and logical partitions. Each individual physical storage device, such as a fixed-disk drive provided by a NAS server, is called a physical volume. Each physical volume is assigned to a volume group, which is a collection of physical volumes of varying sizes and types. When a physical volume is assigned to a volume group, the physical blocks of storage media on it are organized into physical partitions of a size specified by an administrator when the volume group was created.

One or more logical volumes are defined within each volume group. Logical volumes are groups of information located on physical volumes. Data on logical volumes appears to be contiguous to the user but can be discontiguous on the physical volume. This allows a logical volume to be easily resized, relocated, replicated, or span multiple physical volumes. Each logical volume consists of one or more logical partitions, which correspond to at least one physical partition.

In order to incorporate the storage capacity provided by a remote NAS server in a network, a system administrator typically interacts with a Logical Volume Manager (LVM). The LVM is often provided by an operating system executing on a server connected to the network. The LVM is a set of operating system commands, library subroutines, and other tools by which the administrator establishes and controls disk resources by mapping the storage capacity of the NAS server into the logical hierarchy described above.

Once a NAS server is incorporated into a file system via the LVM, the additional storage capacity is typically available to users and applications through a new folder or directory presented by the file system.

### SUMMARY

Unlike conventional storage technologies, the invention seamlessly and dynamically detects a NAS server and automatically incorporates the NAS server into one or more logical storage spaces. The additional storage capacity may be automatically incorporated into an existing logical storage space or into a new space based on one or more pre-defined policies. In this manner, the invention facilitates the construction of a storage system that appears as a seamless, single point of storage that can be dynamically expanded to increase storage capacity. This allows an administrator to grow an existing logical storage space simply by connecting a new NAS server to the network.

In one embodiment, the invention is directed to a method in which the attachment of a remote storage device to a network is detected and the remote storage device is automatically incorporated into a new or existing logical storage volume. A size of a logical storage space provided by a file system is automatically expanded to include the additional storage capacity. The storage capacity is incorporated according to one or more pre-defined policies set by a system administrator or other user. The attachment of the remote storage device may be detected in a number of ways, including intercepting a request for an IP address when the remote NAS storage device is coupled to the network.

To incorporate the storage capacity, a network-based connection is formed with the remote storage device such that a logical volume manger can configure the storage device as if it were locally attached. For example, a physical volume is created for the remote storage device and the physical volume is added to a volume group based on the pre-defined policies.

In another embodiment, the invention is directed to a computer-readable medium carrying instructions for causing a programmable processor to detect the attachment of a remote storage device to a network and automatically incorporate storage capacity of the remote storage device into a new or existing logical storage volume.

In another embodiment, the invention is directed to a computing network in which a client computer is coupled to a storage GNAS) master and configured to access a logical storage volume. The storage (NAS) master is coupled to a second network having one or more remote NAS storage devices and configured to automatically incorporate storage capacity of the remote storage devices into the logical storage volume when remote NAS storage devices are attached to the network.

The invention can provide a number of advantages. For example, a system administrator may simply connect a NAS storage device to a network when storage space is running low with the advantage that the additional storage capacity can be automatically incorporated without further intervention by the administrator. Another advantage is that the logical storage space can appear as a single point of storage in which a single file can span multiple storage devices, unlike many conventional storage systems that incorporate hierarchical storage management (HSM) systems.

The details of one or more embodiments of the present invention are set forth in the accompanying drawings and the description below. Other features, objects, and advantages of the present invention will be apparent from the description and drawings, and from the claims.

### BRIEF DESCRIPTION OF THE DRAWINGS

FIG. 1 is a block diagram illustrating a storage network configured according to the invention.

FIG. 2 is a block diagram illustrating a storage network coupled to a second network via a NAS master.

FIG. 3 is a block diagram illustrating one embodiment of a NAS master.

FIG. 4 is a flow diagram illustrating an example process of dynamically expanding an existing logical storage space to include storage capacity provided by a NAS server.

FIG. 5 is a flow diagram illustrating in further detail the dynamic expansion of an existing logical volume.

### DETAILED DESCRIPTION

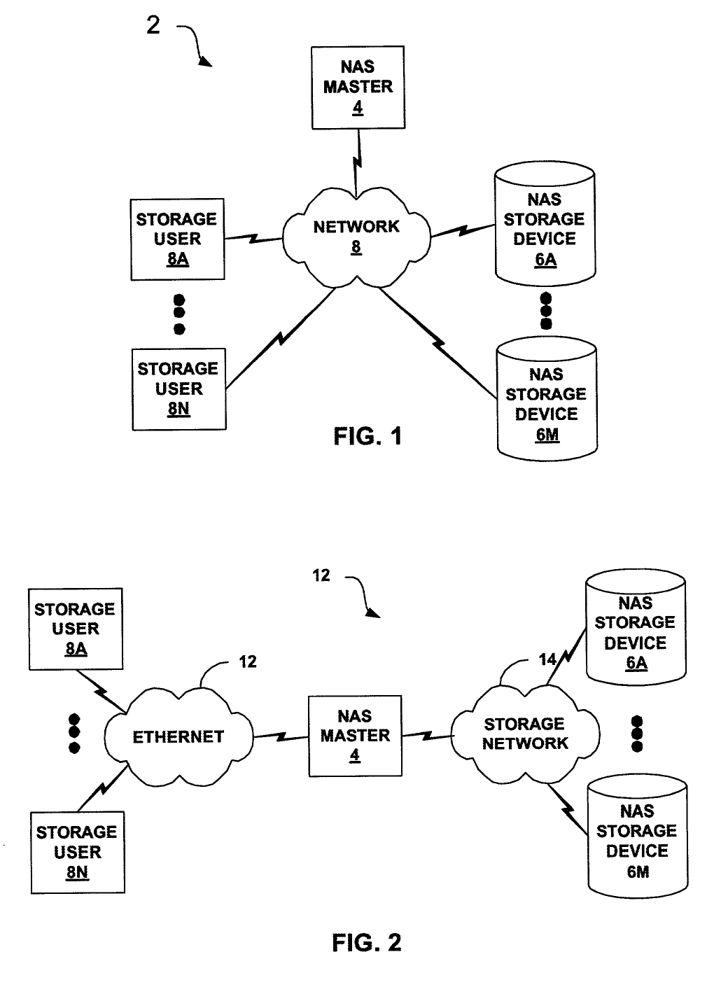

FIG. 1 is a block diagram illustrating an example system 2 in which one or more storage users 8 store data on one or more logical storage spaces provided by NAS storage devices 6. Storage users 8 communicate with NAS storage devices 6 via network 8, which may be any communication network such as an Ethernet-based network running TCP/IP, NetBEUI or other communication protocols. NAS storage devices 6 represent self-contained data storage devices that attach directly to network 8. A NAS storage device 6 may include optical media, individual hard drives, tape drives, and the like, alone or in combination. As described below, NAS storage devices 6 can be dynamically connected to network 8 and incorporated into one or more existing logical storage spaces, such as particular users' folders or directories.

NAS master 4 detects the connection of one or more new NAS storage devices 6 to network 8 and automatically incorporates the additional storage capacity into one or more logical volumes. After incorporating the new storage device 6, NAS master 4 expands the file system to increase the size of the logical storage space to include the additional capacity. This advantageously allows a system administrator to simply connect a NAS storage device 6 to network 8 when storage space is running low. NAS master 4 automatically incorporates the new device without further intervention from the system administrator.

NAS master 4 may add the new device to one or more new or existing logical volumes based on pre-configured policies. For example, one policy may instruct NAS master 4 simply to add all storage to a particular existing logical volume within the file system. Other policies may prioritize the available logical volumes based on the allocated users or based on the remaining storage space in each existing volume. Furthermore, NAS master 4 may divide the new storage capacity and allocate portions to different existing logical volumes.

In one configuration, NAS master 4 operates as a host conforming to the Dynamic Host Configuration Protocol (DHCP), which is a protocol for dynamically assigning Internet Protocol (IP) addresses to devices on a network, such as NAS storage devices 6 on network 8. In this configuration, NAS master 4 maintains a pool of IP addresses and assigns IP addresses to NAS storage devices 6 when the devices 6 connect to network 8. As described below, software executing on NAS master 4 intercepts requests for IP addresses in order to detect the addition of a new NAS storage device 6. In addition to operating as a DHCP server and assigning the new NAS storage device 6 an IP address, NAS master 4 automatically incorporates the additional storage capacity into one or more existing logical storage spaces. Typically, NAS storage device 6 provides NAS master 4 with a unique address, referred to a Universal Unique Identifier (UUID), which is usefull in determining whether the storage space provided by NAS storage device 6 has been previously incorporated in a logical storage space.

In another configuration, NAS storage devices 6 operate according to a multi-cast protocol and announce their presence on network 8. In this configuration, NAS master 4 detects a new device 6 by listening for multi-cast messages from new devices. Upon detecting a new device 6, NAS master queries a table of UUID's to determine whether the device 6 has been incorporated into a logical volume. NAS master 4 and NAS storage devices 6 may be equipped with Jiro™ management facades that enable integration and implementation of a series of storage policies.

FIG. 2 is a block diagram in which storage users 8 are coupled to NAS master 4 via a first network 12 while NAS storage devices 6 are coupled to NAS master via storage network 14. This configuration advantageously keeps communication packets between NAS master 4 and NAS storage devices 6 separate from communication packets between NAS master 4 and storage users 8. In this configuration, NAS master 4 may be connected to network 12 via a first Ethernet card and connected to storage network 14 via a second Ethernet card. In this arrangement, NAS mater 4 handles routing packets between the networks 12 and 14.

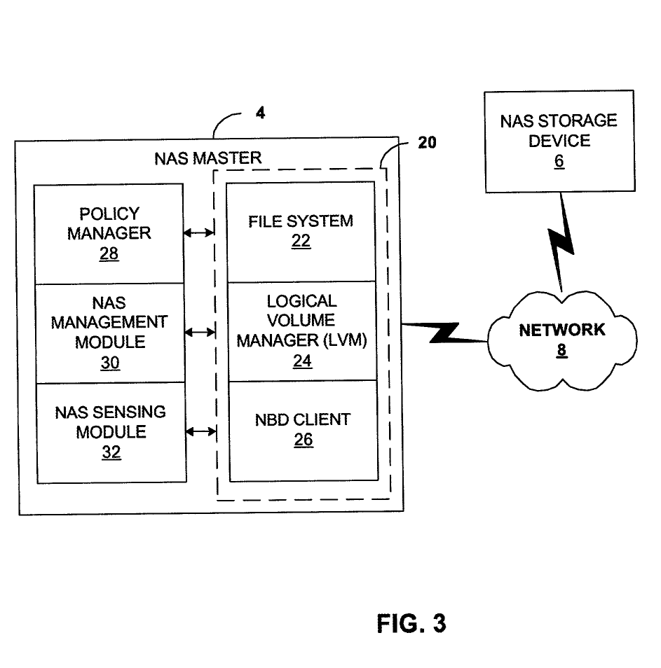

FIG. 3 is a block diagram illustrating one embodiment of NAS master 4. In this embodiment, an operating system 20 executes on NAS master 4 and provides many file management and data storage services including file system 22, logical volume manager (LVM) 24 and NDB client 26. In one embodiment, operating system 20 comprises the Linux operating system.

Network Block Device (NBD) client is a device driver extension for operating system 20 that creates TCP/IP network connections between NAS master 4 and NAS storage devices 6. To the remaining components of operating system 20, the interface to the formed network connections makes remote storage devices 6 appear as local storage devices. Applications on the NAS master 4 can seamlessly access files or partitions located on the remote computer. The NBD client 26 forwards storage requests from storage users 8 to remote NAS storage devices 6. Remote storage devices 6 include a software module (not shown) that communicates with NBD client 26 and provides access to the remotely stored data.

NAS master 4 may support other protocols in addition to the NBD protocol for seamlessly connecting to remote NAS storage devices 6. For example, NAS master 4 may support the Internet Small Computer System Interface (ISCSI) protocol, which allows SCSI-based storage access requests over a TCP/IP based network and dynamic IP addressing. In this embodiment, NDB client 26 and NAS sensing module 32 are configured to support the ISCSI protocol.

LVM 24 establishes and controls NAS storage device 6 by mapping the storage capacity of the NAS storage device 6 into one or more logical volumes. Typically, a logical volume manager configures and controls local storage devices. However, because NBD client 26 presents a seamless interface to remote NAS storage device 6, LVM 24 can control NAS storage device 6 as if NAS storage device 6 were local and directly attached to NAS master 4.

While servicing storage users 8, file system 22 receives storage access requests and issues block request to the LVM 24. LVM 24 determines which volume group serves the requested logical volume and which physical volume serves the corresponding volume group. LVM 24 then makes a block request to a storage resource associated with the physical device. For example, the storage resource may be a SCSI drive or IDE drive attached to NAS storage device 6.

NAS sensing module 32 detects the connection of one or more new NAS storage devices 6 to network 8 and informs NAS management module 30 of the new device. NAS management module 30 interacts with LVM 24 to automatically incorporate the additional storage capacity into one or more existing logical storage spaces. Policy manager 28 allows a system administrator to define and control the various policies for adding new storage devices to particular volumes. When a new device has been detected, NAS management module 30 queries policy manager 28 to determine one or more appropriate logical volumes in which to incorporate the additional storage capacity. After incorporating the new storage device 6, NAS management module invokes file system 22 and expands the space available in files system 22 accordingly.

Although described as separate modules, the intelligence and functionality of policy manger 28, NAS management module 30 and NAS sensing module 32 may be incorporated into operating system 20, such as within LVM 24.

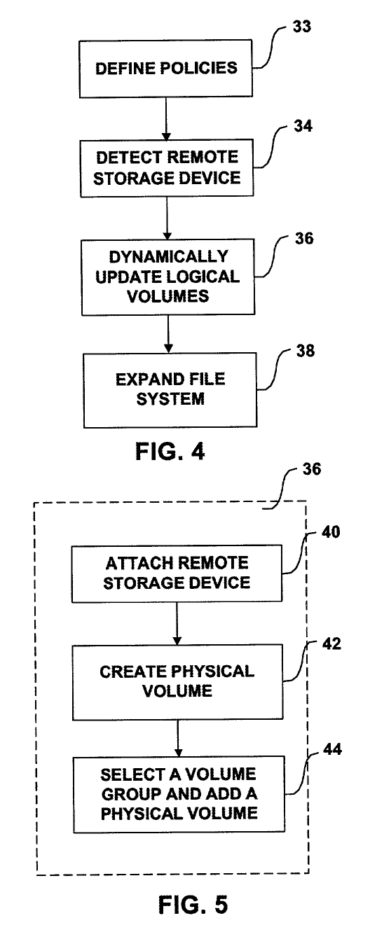

FIG. 4 is a flow diagram illustrating an example process by which NAS master 4 dynamically expands an existing logical storage space to include storage capacity provided by a NAS storage device 6. First, a system administrator interacts with policy manager 28 to set one or more policies that define how new NAS storage devices 6 should be automatically incorporated into new or existing logical storage spaces (33). For example, the system administrator may set a policy that instructs NAS master 4 to add all storage to a particular logical volume within the file system. The system administrator may also set policies that prioritize the available logical volumes based on the allocated users or based on the remaining storage space in each existing volume. Furthermore, the administrator may interact with policy manager to define one or more policies for dividing new storage capacity and allocating portions to different logical volumes.

Next, NAS sensing module 32 of NAS master 4 senses the addition of a remote NAS storage device 6 (34). As described above, in one configuration NAS master 4 operates as a DHCP server. In this configuration, NAS sensing module 32 intercepts a DHCP request for an IP address as devices are added to the network. In another configuration, NAS master 4 detects a new NAS storage device 6 by listening for multicast messages.

After detecting a new device, NAS management module 30 automatically updates one or more existing logical volumes to incorporate additional storage space available on the newly attached remote NAS storage device 6 (36). This process is explained in further detail below in reference to FIG. 5.

After incorporating the incorporate additional storage space in one or more existing logical volumes, NAS management module 30 interacts with file system 22 to expand the file system based on the newly available storage area and adjusted logical volumes. For example, in one configuration, NAS management module 30 may make one or more kernel calls to file system 22 to increase the size of an existing logical storage space. In this manner, NAS master 4 automatically detects and incorporates storage capacity of a newly attached NAS storage device into one or more existing single points of storage in a file system.

FIG. 5 is a flow diagram illustrating in farther detail the dynamic incorporation of the storage capacity of a newly detected NAS storage device 6 into a new or existing logical storage volume. First, NAS management module 30 attaches the remote NAS storage device 6 to LVM 24 by instantiating NBD client 26, which creates a transparent TCP/IP connection between LVM 24 and the newly detected NAS storage device 6 (40). In this manner, remote NAS storage device 6 appears to be physically attached to NAS master 4.

Next, NAS management module directs LVM manager 24 to create a physical volume is created for the new storage device (42). Once a physical volume is created, NAS management module 30 directs LVM manager 4 to add the physical volume to an existing volume group based on the policies set within policy manager 28 (44). Once added to a volume group, the physical volume becomes part a corresponding logical volume. In one embodiment, NAS management module 30 interacts with an application program interface (AP)I provided by operating system 20 to direct LVM 24. In another embodiment, NAS management module 30 passes commands and parameters to LVM 4 via a command line interface.

A number of embodiments of the invention have been described. Nevertheless, it will be understood that various modifications may be made without departing from the spirit and scope of the invention. Accordingly, these and other embodiments are within the scope of the following claims.

What is claimed is:

1. A method comprising:
detecting the attachment of a remote storage device to a network; and
automatically incorporating storage capacity of the remote storage device into a logical storage volume.

2. The method of claim 1, wherein incorporating the storage capacity comprises incorporating the storage capacity into an existing logical volume.

3. The method of claim 1, wherein incorporating the storage capacity comprises incorporating the storage capacity into a new logical volume.

4. The method of claim 1, further comprising automatically expanding a size of a storage space provided by a file system to include the storage capacity.

5. The method of claim 1, wherein incorporating the storage capacity comprises incorporating the storage capacity according to one or more pre-defined policies.

6. The method of claim 5, wherein incorporating the storage capacity comprises:
forming a network-based connection with the remote storage device;
creating a physical volume for the remote storage device; and
adding the physical volume to a volume group.

7. The method of claim 5, further comprising selecting the volume group from a number of volume groups based on one of the pre-defined policies.

8. The method of claim 1, wherein detecting the attachment of the remote storage device comprises intercepting a request from the remote storage device for an Internet Protocol (IP) address.

9. The method of claim 1, wherein detecting the attachment of the remote storage device comprises receiving a multicast message from the remote storage device.

10. The method of claim 1, wherein incorporating the storage capacity comprises automatically controlling a logical volume manager (LVM) in response to the detected remote storage device.

11. The method of claim 8, wherein automatically controlling the LVM comprises:
instantiating a network driver to form a network-based connection with the remote storage device;
directing the LVM to create a physical volume for the remote storage device as if the remote storage device were local to the LVM; and
directing the LVM to add the physical volume to a volume group.

12. A computer-readable medium having instructions contained therein for causing a programmable processor to:
detect the attachment of a remote storage device to a network; and
automatically incorporate storage capacity of the remote storage device into a logical storage volume.

13. The computer-readable medium of claim 12, wherein the instructions cause the processor to incorporate the storage capacity into an existing logical volume.

14. The computer-readable medium of claim 12, wherein the instructions cause the processor to incorporate the storage capacity into a new logical volume.

15. The computer-readable medium of claim 12, wherein the instructions cause the processor to automatically expand a size of a storage space provided by a file system to include the incorporated storage capacity.

16. The computer-readable medium of claim 12, wherein the instructions cause the processor to incorporate the storage capacity according to one or more pre-defined policies.

17. The computer-readable medium of claim 12, wherein the instructions cause the processor to:
form a network-based connection with the remote storage device;
create a physical volume for the remote storage device; and
add the physical volume to a volume group.

18. The computer-readable medium of claim 17, wherein the instructions cause the processor to select the volume group from a number of volume groups based on a pre-defined policy.

19. The computer-readable medium of claim 12, wherein the instructions cause the processor to intercept a request from the remote storage device for an Internet Protocol (IP) address.

20. The computer-readable medium of claim 12, wherein the instructions cause the processor to receive a multicast message from the remote storage device.

21. The computer-readable medium of claim 12, wherein the instructions cause the processor to automatically control a logical volume manager (LVM) in response to the detected remote storage device.

22. The computer-readable medium of claim 21, wherein the instructions cause the processor to:
instantiate a network driver to form a network-based connection with the remote storage device;
direct the LVM to create a physical volume for the remote storage device as if the remote storage device were local to the LVM; and
direct the LVM to add the physical volume to a volume group.

23. A system comprising:
a logical volume manager (LVM) executing in an operating environment provided by a computer;
a network attached storage (NAS) sensing module configured to detect the attachment of a remote storage device to a network; and
a NAS management module configured to interact with the LVM and automatically incorporate storage capacity of the detected remote storage device into a logical storage volume.

24. The system of claim 23, wherein the NAS management module directs the LVM to incorporate the storage capacity into an existing logical volume.

25. The system of claim 23, wherein the NAS management module directs the LVM to incorporate the storage capacity into a new logical volume.

26. The system of claim 23, wherein the NAS management module automatically expands a size of a logical storage space provided by the operating environment to include the storage capacity of the remote storage device.

27. The system of claim 23, further comprising a policy manager to define one or more policies for incorporating the storage capacity of the remote storage device.

28. The system of claim 23, wherein the NAS management module directs the LVM manager to incorporate the storage capacity by forming a network-based connection with the remote storage device, creating a physical volume for the remote storage device and adding the physical volume to a volume group.

29. The system of claim 28, wherein the NAS management module selects the volume group from a number of volume groups based on the policies defined by a policy manager.

30. The system of claim 29, wherein the NAS sensing module intercepts a request from the remote storage device for an Internet Protocol (IP) address.

31. The system of claim 23, wherein the computer is configured to maintain a pool of IP addresses and conform to the Dynamic Host Configuration Protocol (DHCP), and further wherein the NAS sensing module is configured to intercept a request from the remote storage device for an IP address.

32. The system of claim 23, wherein the NAS sensing module is configured to receive a multicast message from the remote storage device.

33. The system of claim 23, wherein the NAS management module is configured to automatically instantiate a network driver to form a network-based connection with the remote storage device, direct the LVM to create a physical volume for the remote storage device as if the remote storage device were local to the LVM and directing the LVM to add the physical volume to a volume group.

34. A system comprising:
a network attached storage (NAS) device; and
a NAS master remotely coupled to the NAS device via a first network and configured to automatically incorporate storage capacity of the storage device into a logical storage volume when the NAS storage device is attached to the first network.

35. The system of claim 34 further comprising a client computer coupled to the NAS master via a second network and configured to access the logical storage volume.

36. The system of claim 34, wherein the NAS master is configured to automatically expand a size of a storage space mapped to the logical volume.

37. The system of claim 34, wherein the NAS master comprises a policy manager to define one or more policies for incorporating the storage capacity.

38. The system of claim 34, wherein the NAS master is configured to maintain a pool of IP addresses and conform to the Dynamic Host Configuration Protocol (DHCP).

39. A method comprising:
adding a remote storage device to a network; and
incorporating the storage capacity of the remote storage device into the network without substantial human intervention.

40. The method of claim 39, wherein incorporating the storage capacity comprises:
detecting the attachment of a remote storage device to a network; and
automatically incorporating storage capacity of the remote storage device into a logical storage volume.

41. The method of claim 39, wherein incorporating the storage capacity comprises incorporating the storage capacity into an existing logical volume.
